(19) United States
(12) Patent Application Publication
(10) Pub. No.: US 2010/0188068 A1
(43) Pub. Date: Jul. 29, 2010

(54) Solid State High Power Piezokinetic Transformer and Method Thereof

(75) Inventors: Gareth J. Knowles, Williamsport, PA (US); Ross Bird, Canton, PA (US)

Correspondence Address: CAHN & SAMUELS LLP, 1100 17th STREET NW, SUITE 401, WASHINGTON, DC, 20036, US

(73) Assignee: QORTEK, INC., Williamsport, PA (US)

(21) Appl. No.: 12/692,454

(22) Filed: Jan. 22, 2010

Related U.S. Application Data
(60) Provisional application No. 61/146,743, filed on Jan. 23, 2009.

(51) Int. Cl. H01F 38/16

(52) U.S. Cl. 323/355; 310/318

(57) ABSTRACT

Disclosed is high efficiency power multiplying piezo transformer architecture having at least one piezo transformer assembly, the at least one piezo transformer assembly including of a plurality of piezo transformers circuits including a first outer and last outer piezo transformer circuits, each of the piezo transformer circuits having a primary side having a positive and negative electrode or terminal and a secondary side having a positive and a negative electrode or terminal. Each of the plurality of piezo transformer circuits forming the piezo transformer assembly is coupled to an adjacent piezo transformer circuit wherein the positive electrode of the primary side of each the piezo transformer circuit is coupled to a first node and each negative electrode of the primary side of each piezo transformer circuit is coupled to a second node. A signal conditioning component having first and second inputs, the positive electrode of the secondary side of the first outer piezo transformer circuit of the piezo transformer assembly coupled to the first input of the signal conditioning (rectifier) circuit and the negative electrode of the secondary side of the last outer piezo transformer of the piezo transformer assembly. The negative electrode of the first outer piezo transformer of the piezo transformer assembly is coupled to the positive electrode of a piezo transformer of the plurality and the negative electrode of the secondary side of a piezo transformer circuit of the plurality being coupled to the positive electrode of the second outer piezo transformer circuit.

### PRIORITY CLAIM

This application claims the benefit of U.S. Provisional Application Ser. No. 61/146743 filed on Jan. 23, 2009 which is incorporated herein by reference.

### FIELD OF THE INVENTION

This invention relates in general to the field of solid state transformers and in particular to the field of piezoelectric transformers and methods for using the same.

### DESCRIPTION OF THE PRIOR ART

The early designs to transform an input ac voltage to step up or step down using converse and direct piezoelectric properties of ceramic materials was proposed by Rosen in the 1950's. Piezoelectric transformers can be classified into two types: One type is used as a step-up transformer, in which the voltage gain is larger than one. Another type is used as step-down transformers with voltage gain of less than one. As single plate structure is normally used to achieve step-up transform, while a multilayer structure is normally employed to achieve a step-down structure Unlike the magnetic transformer circuits piezoelectric-based transformer circuits use frequency rather than duty cycle to control output current to the load. Typically, the principle of this type of transformer excites a piezoelectric mechanism at one of its mechanical resonance frequencies, usually the first or third mode. Applying an electrical input to one part of the piezoelectric element (input electrodes side) generated a mechanical vibration and then this mechanical vibration is re-converted into electrical voltage from the other portion (output electrodes side) of the piezoelectric plate. The voltage step-up ratio for unloaded condition (open circuited) is provided by:

r∝k₃₁k₃₃Qₘ(L/t)

where, L and t are the electrode gap distances for the input and output parts, respectively. Note increasing the length/thickness ratio, electromechanical coupling factors (k31, k33) and/or mechanical quality factor (Qm) are key to increasing step-up ratio. Rosen-type transformers were trial tested on color TVs in 1970's. Typically, these designs had reliability problems that caused mechanical breakdown at the center position due to the coincidence of the residual stress concentration (through the poling process) and the vibration nodal point (highest induced stress).

Current piezo transformers are generally very reliable and have significant step-up ratio capability. Typically, these piezoelectric transformers are classified into two groups: resonance and off-resonance types. The off-resonance type is for step-down transformers used for precise measurements of high voltage such as 30 kV or high current on electric power transmission lines. The resonance type is further divided into two groups: step-up types typically used as high-voltage inverters for the LCD back-lights and step-down types used as AC-DC converters. For example, NEC has developed a multilayer type transformer, where a higher voltage step up ratio was realized in proportion to the number of layers of the input part.

ICAT (State College, Pa—the University forerunner of MMech) recently developed a 30W multi-layer stacked disk type transformers for NASA. One of the primary issues under this program is to redesign these 30W piezotransformer for optimal performance at ×200 gain (they are theoretically capable of up to ×300). Addressing the voltage up conversion issue to 6 kV is a straightforward design, however, how to correctly design and efficiently concatenate such 30W transformers as to yield the desired 250-300W capable DC-DC converter for sparker source with the same very high efficiency of the core 30W piezotransformers has heretofore been unaddressed.

U.S. Pat. No. 5,757,106 discloses a piezoelectric ceramic transformer having a rectangular parallelepiped piezoelectric ceramic plate divided into a generator section and driving sections on both sides of the generator section. This patent also discloses a first ring-shaped input electrodes and second ring-shaped input electrodes are alternately put on the rectangular parallelepiped piezoelectric ceramic plate at intervals so as to create electric field perfectly oriented in the longitudinal direction of the ceramic plate.

U.S. Pat. No. 6,331,748 discloses a fixed frequency driving circuit of a piezo-ceramic transformer capable of controlling an input voltage. The driving circuit includes a lamp; a PCT(Piezo-Ceramic Transformer) for driving the lamp; a PCT driving circuit for driving the PCT; a voltage doubler rectifier for rectifying an output voltage; a summing & error amplifying circuit for outputting by summing a dimming voltage and the output voltage; a charge pump circuit for maintaining zero voltage switching and reducing the switching loss; a temperature compensated VCO for compensating the temperature characteristics of PCT, and impact, etc. in the neighborhood; a phase detector for comparing the phase of the input and output signal of the PCT; a modulator capable of continuously obtaining an amplitude of a first harmonic frequency component when the input voltage is changed from Vmin to Vmax by controlling a duty ratio provided to a driver connected to the PCT according to the output signals of the phase detector and the summing & error amplifier.

U.S. Pat. No. 6,597,084 discloses a ring-shaped piezoelectric transformer for low voltage applications. One surface of the transformer is covered by two disc or ring-shaped electrodes separated by a ring-shaped separating segment, and the regions covered by the disc or ring-shaped electrodes served as the input and output parts of the transformer. This transformer may be fabricated relatively easily due to its simple structure. Furthermore, its size and thickness may be reduced relatively easily without increasing the difficulty of the fabricating process. The transformer may be used separately or in parallel.

U.S. Pat. No. 7,053,532 discloses a piezoelectric diaphragm structure including a diaphragm, with a piezoelectric material located on the diaphragm. The piezoelectric material is poled in a radial direction to the piezoelectric material, wherein the poling direction is in-plane with the piezoelectric material. An interdigitated electrode grid is positioned on a first surface of the piezoelectric material, the interdigitated electrode grid including a plurality of electrodes configured to selectively receive positive and negative voltage. The application of the positive and negative voltages generate electric fields in the piezoelectric material, at least a portion of which are in-plane with the piezoelectric material, resulting in an actuation of the piezoelectric material, causing a length change of the piezoelectric material in the Radial direction. In accordance with another embodiment of the present application, provided is a method of actuating a piezoelectric diaphragm structure, including poling a piezoelectric material in a radial direction of the piezoelectric material, wherein the poling direction is in-plane with the piezoelectric material. The piezoelectric material is located in operative contact with the diaphragm, and an electrode arrangement located on a surface of the piezoelectric material is selectively supplied with voltages generating electric fields. The generated electric fields are at least partially in the same plane as the poling direction, resulting in a d.sub.33 mode of actuation of the piezoelectric material, causing a length change of the piezoelectric material in the Radial direction.

U.S. Pat. No. 6,278,226 discloses a piezo ceramic transformer working at a full wave length mode, .lambda.-mode, having a driving region divided into two sections in the center and two generating regions at the end regions of a thin rectangular bar. Two input sections are built into multi-layered structure with multiple internal-electrodes and poled along the thickness direction with polarization in the neighboring layers opposite to each other. Alternating internal electrodes are connected in parallel through two external electrodes in each input section. Polarization in the same layer of two input sections are disposed in the same direction, and two external electrodes of two input sections in the same side of driving region are connected 180 degree out of phase to each other to a driving circuit. Two CCFLs are connected directly to two output electrodes at the end of the piezo ceramic transformer, respectively. Polarization in two output sections is along the length of the piezo ceramic plate, but the respective direction is in opposite way. Alternatively, polarization in the same layer of the two input sections are disposed in opposite direction, and two external electrodes of two input sections in the same side are connected in phase to each other to a driving circuit.

U.S. Pat. No. 6,362,559 discloses a piezoelectric transformer having segmented electrodes on one or both faces of a piezoelectric ceramic disk. Application of a voltage sequentially to one or more adjacent segments forms a traveling wave in the disk. Application of a voltage to alternate segments forms a resonant standing wave in the disk. The transformer may be configured with a resonant feedback circuit that provides step up voltage transformation, and may provide voltage to multiple loads.

U.S. Pat. No. 6,960,871 discloses a piezoelectric transformer having a layered structure formed by alternately stacking a plurality of internal electrodes and a plurality of piezo-electric ceramics layers in thickness direction, first electrodes formed on side surfaces of said layered structure and connected to said internal electrodes, at least one pair of second electrodes formed on the side surfaces in areas different from those of the first electrodes and having a same potential, and a circuit board for driving the piezoelectric transformer. The piezoelectric transformer is mounted on the circuit board. Each of the at least one pair of the second electrodes opposite to each other is electrically connected to the circuit board.

The structure, size, vibration mode and power output method of piezoelectric transformers will affect its own input and output impedance characteristics, thus affecting the output power and efficiency of power conversion. The issue is that there are fundamental limits due to physical behavior that will strictly limit the power handling capability of any piezotransformer device. As such there is substantial interest in multiple connected piezoelectric circuits are significant for applications such as power processing. To overcome the power limitation using multiple connected piezoelectric circuits, the standard (such as taken by Nihon Ceratec and NEC-Tokin) has been to introduce an input-parallel and output-parallel connection. The problem with this approach is that it typically results in a loss in efficiency that rapidly degenerates as each additional piezotransformer is added. One major cause for such degenerate efficiency performance of the resulting piezotransformer assembly is that, in practice, each piezotransformer circuit or transducer will have a slightly different resonant frequency. These variances in resonance frequency are typically due to the variances in the piezoelectric materials, manufacturing tolerances, job lot, or even differences (physical and design) aspects of the plurality of piezo transformers. These resonant frequency variances are typically addressed through the use of individual rectifier/inverter or other signal conditioning devices. Additionally, input-parallel and output-parallel connection cause a known power balance issues closely related to thermal failure of the piezoelectric assembly due to thermal runaway. This phenomena is discussed in the article “Design Consideration of Parallel—Parallel Connected Piezoelectric Transformer for Thermal Balance,” by Joung-Hu Park, Sang-Min Lee, Sung-Jin Choi, and Bo-Hyung Cho; Japan Journal of Applied Physics 46 (2007) pp. 7067-7072. The issue is that any variation in mechanical resonance of individual piezotransformer circuits in a input-parallel and output-parallel connection topology will cause current flow between adjacent devices. The current flow will overdrive at least one of the devices and a significant reduction in overall efficiency. In the past solutions to the degenerate loss of efficiency have taken one of two approaches.

One approach has been to drive each piezo transformer circuit with a variable phase drive signal. This solution has been found to be needlessly complicated and inefficient to the point of seeing very little use. The typical approach is to drive the plurality of piezo transformer circuits forming the piezo transformer with a single drive signal and individually condition the output of each piezoelectric transformer circuit forming.

FIG. 1 illustrates a block diagram of a piezoelectric transformer 100 using the second approach as typical in the prior art. The piezoelectric transformer 100 features a plurality of piezoelectric transformer circuits 150 coupled in parallel connections on both the primary and secondary side. Typical to the prior art, due to the resonant frequency variances of each piezoelectric transformer circuit 150 and the phase variances that result in each of the piezo transformer circuit's 150 output each transformer's output must be individually conditioned by a rectifier 175 prior to applying the amplified signal.

Each of the signal conditioning devices 175 consume power and add to the size and complexity of the transformer, and ultimately have an negative effect on the efficiency of the transformer 100.

### III. SUMMARY OF THE INVENTION

Disclosed is a method of multiplying the power capability of solid-state piezo transformers without any corresponding loss in efficiency. The invention uses a concatenated interconnect topology between the input sides and output sides of the piezo transformer to facilitate efficient power multiplication. The concatenated topology eliminates thermal runaway, addresses the issue of mechanical resonance imbalance and substantially reduces the electronics component requirements.

In this invention, the piezo transformer has at least one piezo transformer assembly, and the at least one piezo transformer assembly includes of a plurality of piezo transformers circuits including a first outer and last outer piezo transformer circuits, each of the piezo transformer circuits having a primary side having a positive and negative electrode or terminal and a secondary side having a positive and a negative electrode or terminal. Each of the plurality of piezo transformer circuits forming the piezo transformer assembly is coupled to an adjacent piezo transformer circuit wherein the positive electrode of the primary side of each the piezo transformer circuit is coupled to a first node and each negative electrode of the primary side of each piezo transformer circuit is coupled to a second node. A signal conditioning circuit having first and second inputs, the positive electrode of the secondary side of the first outer piezo transformer circuit of the piezo transformer assembly coupled to the first input of the signal conditioning circuit and the negative electrode of the secondary side of the last outer piezo transformer of the piezo transformer assembly. The negative electrode of the first outer piezo transformer of the piezo transformer assembly is coupled to the positive electrode of a piezo transformer of the plurality and the negative electrode of the secondary side of a piezo transformer circuit of the plurality being coupled to the positive electrode of the second outer piezo transformer circuit.

Also disclosed is a piezo transformer including a plurality of piezo transformer circuits forming at least one piezo transformer assembly, each of the piezo transformers circuits of the piezo transformer assembly having a primary side and a secondary side. The primary side of the piezo transformer circuits of the piezo transformer assembly are coupled in parallel, and the secondary side of the piezo transformer circuits of the piezo transformer assembly are coupled in series, wherein the secondary side of the series coupled piezo transformer circuits of the piezo transformer assembly is the output of the transformer.

Also disclosed is a piezo transformer including a plurality of piezo transformer circuits forming at least one piezo transformer assembly, each of the piezo transformers circuits of the piezo transformer assembly having a primary side and a secondary side. The primary side of the piezo transformer circuits of the piezo transformer assembly are coupled in parallel, and the secondary side of the piezo transformer circuits of the piezo transformer assembly are coupled in series, wherein the secondary side of the series coupled piezo transformer circuits of the piezo transformer assembly is coupled to a signal conditioning (rectifier) circuit.

Also disclosed is a method for transforming an electrical signal including: a plurality of piezo transformer circuits the piezo transformer circuits each having a primary and a secondary side and coupling each of the electrodes of the primary side of the piezo transformer circuits such that the orientation of the primary side of the piezo transformer circuits is in parallel. The method also includes coupling the electrodes of the secondary side of each the piezo transformer circuits such that the orientation of the secondary side of the piezo transformer circuits is in series. The disclosed method also includes driving the primary side of the piezo transformer with an alternating signal; and employs a mixed input/output connection topology, concatenated topology, that incorporates both parallel and series connections. The concatenated topology may feature parallel coupling on the primary side and series coupling on the secondary side. The concatenated architecture facilitates rectification via the use of a single rectifier on the output side allowing the use of multiple piezo transformer circuits. Similarly this concatenated topology makes possible the use of a single signal conditioner circuit.

### IV. BRIEF DESCRIPTION OF THE DRAWINGS

In order to describe the manner in which the invention can be obtained, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings.

FIG. 1 illustrates a block diagram of a prior art piezoelectric transformer featuring a plurality of transformers featuring parallel connections on the primary and secondary side.

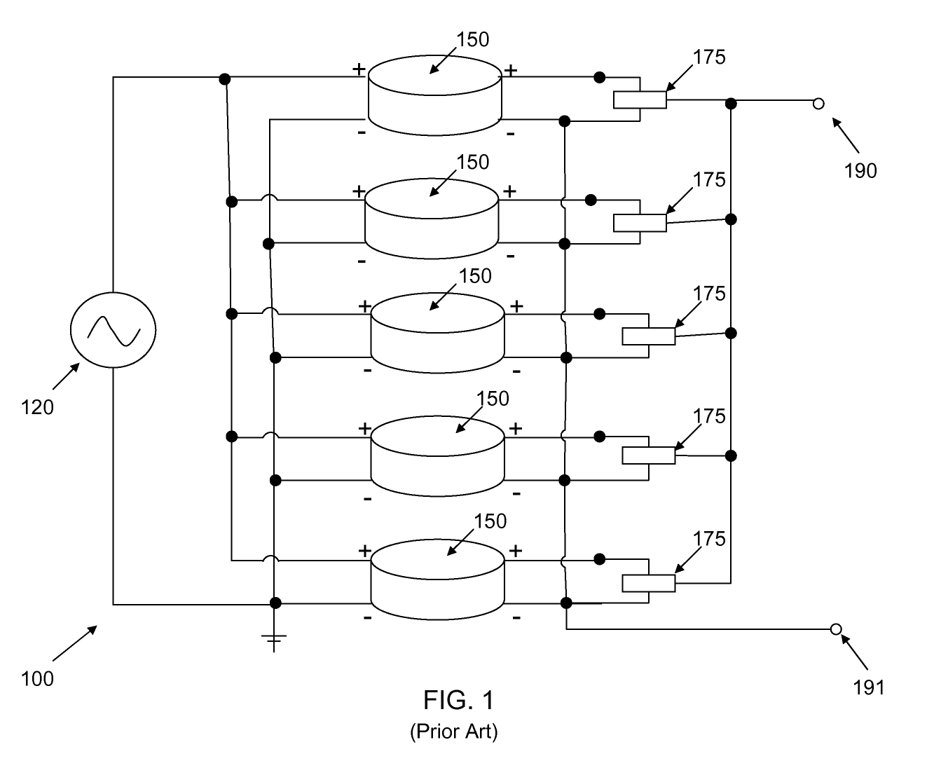

FIG. 2 illustrates a block diagram of an example embodiment of a piezoelectric transformer assembly featuring a plurality of disk-type piezo transformers having parallel coupling on the primary side and series coupling on the secondary side.

FIG. 3 illustrates a block diagram of an example embodiment of a system for a step-up transformer featuring a piezo transformer assembly featuring a plurality of monolithic-type transformers having parallel coupling on the primary side and series coupling on the secondary side.

FIG. 4 illustrates a block diagram of an example embodiment of a system for a transformer featuring a piezo transformer assembly featuring a plurality of multilayer or cofired types of piezo transformers having parallel coupling on the primary side and series coupling on the secondary side.

FIG. 5 illustrates a block diagram of an example embodiment of a system for a step-up transformer featuring a piezo transformer assembly featuring a plurality of monolithic type of piezo transformers in a disc geometry having parallel coupling on the primary side and series coupling on the secondary side.

### V. DETAILED DESCRIPTION

Various embodiments are discussed in detail below. While specific implementations of the disclosed technology are discussed, it should be understood that this is done for illustration purposes only. A person skilled in the relevant art will recognize that other components and configurations may be used without departing from the spirit and scope of the invention. The disclosure relates to a system, apparatus and method for efficiently A method for interconnecting the input and the output of a plurality of piezo transformer circuits as to retain high efficiently and address the phase shift problem common to existing interconnection methods

The disclosed architecture does not require the use of a plurality of signal conditioning circuits. The disclosed piezo transformer architecture allows the concatenation of a plurality of transformed signals and the use of a single signal conditioning device, such as a rectifier or inverter, maximizing the efficiency of the piezo transformer by minimizing power loss due to signal conditioning or destructive signal interference. The disclosed piezo transformer architecture may be employed either to provide a step-up type transformer or step-down type transformer and is applicable to AC or DC signals.

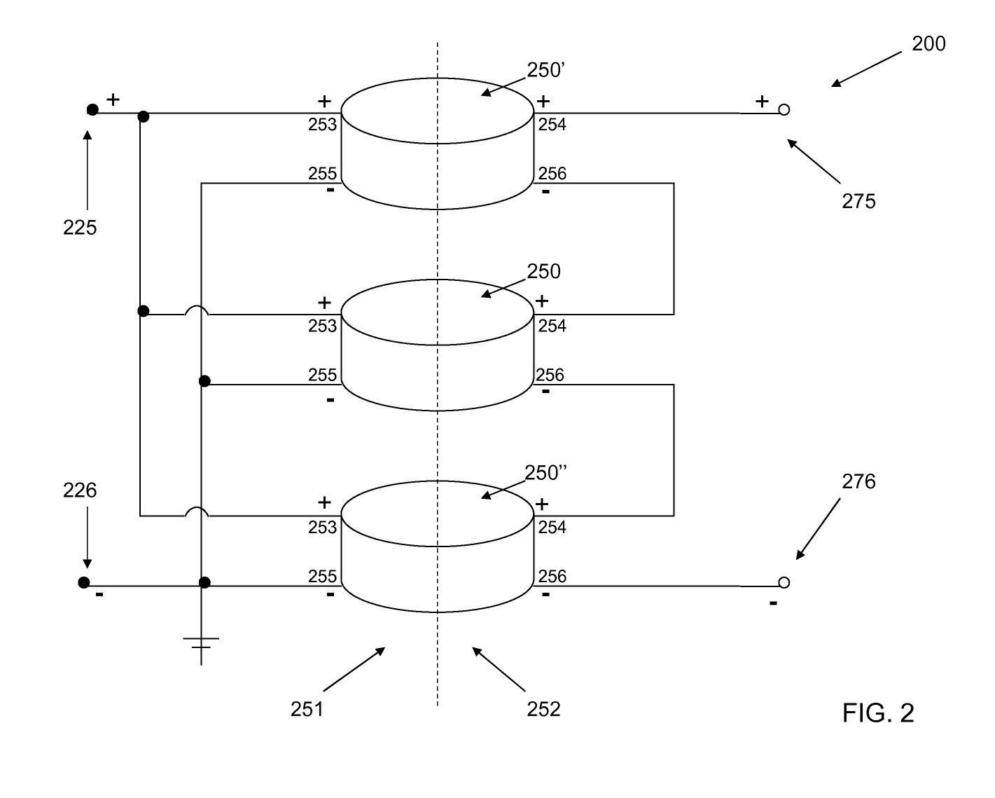

Referring now to the figures, wherein like reference numbers denote like components, elements, or features, FIG. 2 illustrates an example embodiment of a piezo transformer 200 featuring a plurality of piezo transformer circuits 250 including a first piezo transformer circuit 250′ and a last piezo transformer circuit 250″ coupled to drive a common signal.

Each of the piezo transformer circuits 250 are coupled forming a piezo transformer assembly 200. Each of the piezo transformers circuits 250 of the piezo transformer assembly 200 have a primary side 251 and a secondary side 252. The primary side 251 of the piezo transformer circuits 250 of the piezo transformer assembly 200 are coupled in parallel, and the secondary side 252 of the piezo transformer circuits 250 of the piezo transformer assembly 200 are coupled in series, wherein the secondary side 252 of the first and last series coupled piezo transformer circuits 250′ and 250″ respectively of the piezo transformer assembly 200 are used as the output electrodes 275 of the transformer 200.

Specifically, each of the piezo transformer circuits 250 forming the piezo transformer assembly 200 includes a primary side 251 having a positive electrode 253 and a negative electrode 255. The secondary side 252 of each piezo transformer circuit 250 includes positive electrode 254 and a negative electrode 256. On the primary side 251, each of the positive electrodes 253 of the piezo transformer circuit 250 is coupled to a common node 225. Each of the primary side negative electrodes 255 of each of the piezo transformer circuit is coupled to a second common node 226. These common nodes, couple the primary side of the plurality of piezo transformer circuits in parallel with each other. The common nodes 225 and 226 receive the driving signal that can be an AC or DC signal depending on the designated use of the transformer assembly.

The secondary side of each of the piezo transformer circuits forming the piezo transformer assembly shares a different orientation than the primary side. The secondary side 252 of the piezo transformer circuits 250, of the piezo transformer assembly 200 are coupled in series, having a series orientation with the secondary side 252 of the other piezo transformer circuits 250 comprising the piezo transformer assembly 200 instead of the parallel orientation of the primary side 251.

With continued reference to FIG. 2, the positive electrode 254 of the secondary side 252 of the first outer piezo transformer 250′ is the positive output electrode 275 of the piezo transformer assembly. The negative electrode 256 of the secondary side 252 of the last outer piezo transformer 250″ is the negative output electrode 276 of the piezo transformer assembly. The negative electrode 256 of the secondary side 252 of the first outer piezo transformer circuit 250′ is coupled to the positive electrode of the secondary side 252 of the interior transformer circuit 250. The negative electrode 256 on the secondary side 252 of the interior piezo transformer circuit's 250 is coupled to the positive electrode 254 of the secondary side 252 of the adjacent piezo transformer circuit, which in this exemplarily embodiment happens to be the last outer piezo transformer circuit 250″. This architecture effectively couples the secondary side 252 of the piezo transformer circuits 250 forming the piezo transformer assembly in series and eliminates the phase shift problem.

While the exemplarily embodiment shown in FIG. 2 feature three piezo transformer circuits 250, quantity of the plurality of piezo transformer circuits employed by the disclosed piezo transformer architecture is not limited. The quantity of interior piezo transformer circuits 250 employed is not a limitation of this architecture as the architecture may include a plurality of interior transformer circuits 250 having a primary side 251 coupled in parallel and a secondary side 252 coupled in series, or may be simply first and second piezo transformer circuits 250′, 250″ having their primary sides 251 coupled to the other in parallel and their secondary sides 252 coupled to each other in series.

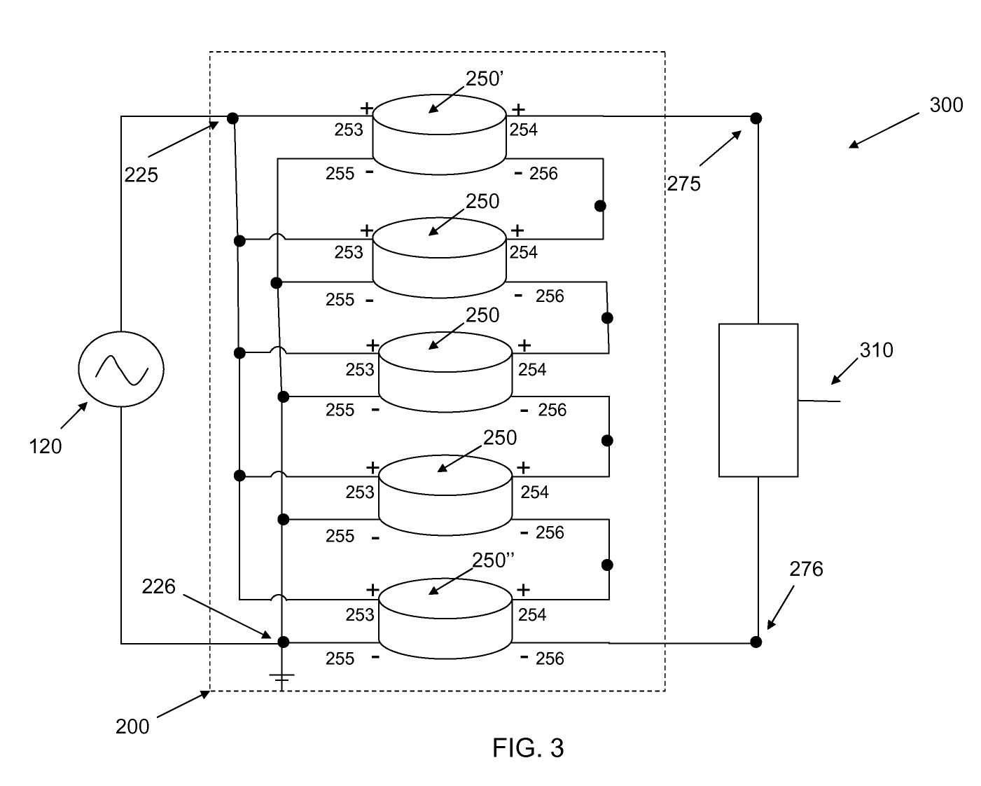

Referring now to FIG. 3 which illustrates an example embodiment of a system for a step-up type piezo transformer 300 having a piezo transformer assembly featuring a plurality of monolithic—type transformers such as disc, and longitudinal bar piezo transformer circuits 250 with parallel coupling on the primary side and series coupling on the secondary side. As shown in the figure, the piezo transformer 300 is driven by a drive signal 120 through a positive node sharing all the positive connections on the primary side and a negative node sharing all the negative connections on the primary side.

The piezo transformer 300 has at least one piezo transformer assembly 200, the at least one piezo transformer assembly including of a plurality of piezo transformers circuits 250 including a first outer 250′ and last outer 250″ piezo transformer circuits, each of the piezo transformer circuits having a primary side having a positive 253 and negative 255 electrode and a secondary side having a positive 254 and a negative 256 electrode. Each of the plurality of piezo transformer circuits 250 forming the piezo transformer assembly 200 is coupled to an adjacent piezo transformer circuit 250 wherein the positive electrode 253 of the primary side of each the piezo transformer circuit 250 is coupled to a first node 225 and each negative electrode 255 of the primary side of each piezo transformer circuit 250 is coupled to a second node 226.

A signal conditioning circuit 310, a rectifier in this example embodiment of a step-up type transformer, having first and second inputs, the positive electrode 254 of the secondary side of the first outer piezo transformer circuit 250′ of the piezo transformer assembly 200 coupled to the first input 275 of the signal conditioning component 310 and the negative electrode 256 of the secondary side of the last outer piezo transformer circuit 250″ of the piezo transformer assembly 200 is coupled to the second input 276 of the rectifier circuit 310. The negative electrode of the first outer piezo transformer circuit 250′ of the piezo transformer assembly 200 is coupled to the positive electrode of an interior piezo transformer 250 of the plurality and the negative electrode of the secondary side of an interior piezo transformer circuit 250 of the plurality being coupled to the positive electrode of the second outer piezo transformer circuit 250″.

In operation, the piezo transformer assembly 200 is driven with a variable waveform input voltage that can either be an AC or pulsed DC. In the example embodiment of FIG. 3 the piezo transformer assembly is driven with an AC waveform generator 120. The drive voltage is stepped up, or stepped down, by each of the piezo transformer circuits 250 of the piezo transformer assembly 200 and as the secondary side of the piezo transformer circuits 250 are arranged in series, the connection topology causes the piezo transformer assembly output voltage to be the sum of the individual step-up or step-down ratio output voltages.

For example, assuming that the drive signal is a 10 volt signal applied to the input electrodes of the of the primary side of the piezo transformer assembly, and each of the piezo transformer circuits of the piezo transformer assembly is a piezo transformer circuit providing an output of at least 30V @ 150 mA with less than a 5W watt input, the concatenated input/output connection topology causes the individual output voltage to be multiplied by the number of piezo transformer circuits of the assembly so driven. The output voltage taken across the positive electrode 275 of the first outer piezo transformer circuit 250′ and the negative electrode 276 of the last outer piezo transformer circuit 250″ approaches 150V at 150 mA as each. In practice piezo transformers employing this architecture have achieved actual outputs of approximately 22.5 watts with each piezo transformer circuit operating at over 90% efficiency as the concatenated signal need only be rectified once, and the destructive interference of phase shifted signals is not a concern. While the exemplary embodiment of FIG. 3 illustrates a step-up type piezo transformer, a step-down type piezo transformer configuration may similarly employ this architecture.

The disclosed piezo transformer architecture is not limited by the number of piezo transformer circuits incorporated into the piezo transformer assembly.

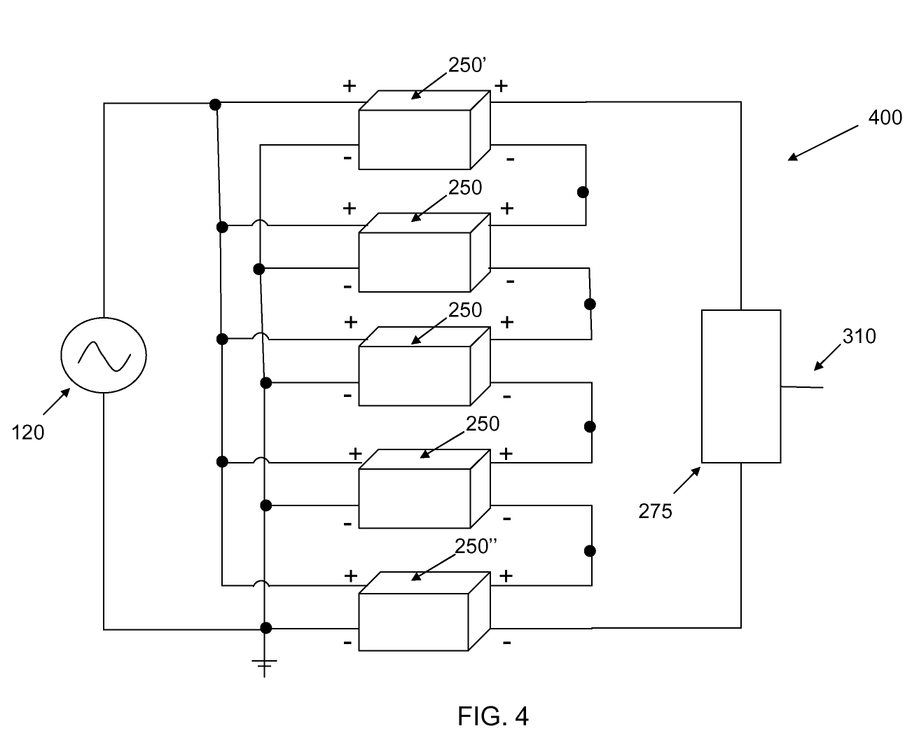

Referring now to FIG. 4 which illustrates yet another embodiment of a system 400 for transforming a signal featuring a piezo transformer assembly featuring a plurality of partly, or fully, cofired or bonded multilayer-type piezo transformers such as Rosen, Transoner, or Unipolar having a concatenated input/output connection topology.

This system configuration is very similar in layout to the piezo transformer shown in FIG. 3, with the exception that this embodiment has a piezo transformer assembly employing a plurality of such piezo transformers circuits.

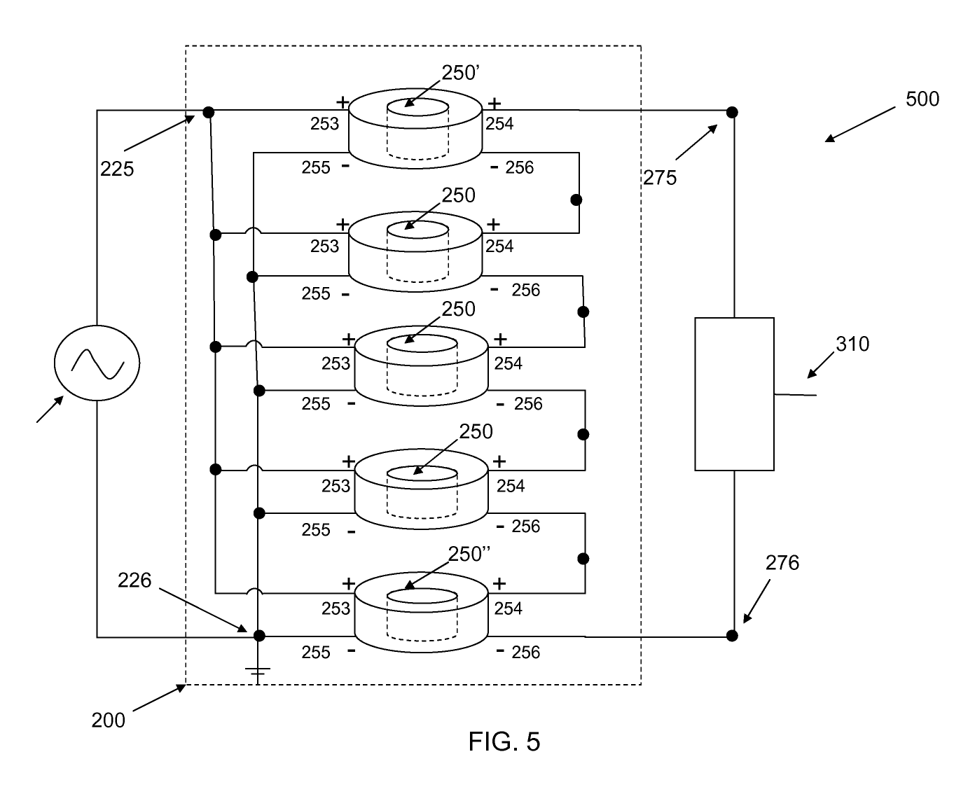

FIG. 5 illustrates yet another embodiment of a system 500 for transforming a signal featuring a piezo transformer assembly featuring a plurality of monolithic or unitary piezo transformers 250 having parallel coupling on the primary side and series coupling on the secondary side.

This system configuration is very similar in layout to the piezo transformers shown in FIGS. 3 and 4, with the exception that this embodiment has a piezo transformer assembly employing a plurality of such piezo transformers circuits 250 rather than the partly, or completely, cofired or bonded multilayer type piezo transformer circuits employed in FIGS. 3 and 4, respectively.

In yet another embodiment the disclosed invention resides in a piezo transformer including a plurality of piezo transformer circuits forming at least one piezo transformer assembly, each of the piezo transformers circuits of the piezo transformer assembly having a primary electrode side and a secondary electrode side. The primary electroded side of the piezo transformer circuits of the piezo transformer assembly are coupled in parallel, and the secondary electroded side of the piezo transformer circuits of the piezo transformer assembly are coupled in series, wherein the secondary side of the series coupled piezo transformer circuits of the piezo transformer assembly may be coupled to a signal conditioning component or circuit such as a rectifier or an inverter.

In yet another embodiment the disclosed invention resides in a method for transforming an electrical signal including: a plurality of piezo transformer circuits the piezo transformer circuits each having a primary electroded and a secondary electroded side, and coupling each of the electrodes of the primary side of the piezo transformer circuits such that the orientation of the primary electroded side of the piezo transformer circuits is in parallel. The method also includes connecting the electrodes of the secondary electroded side of each the piezo transformer circuits such that the orientation of the secondary electroded side of the piezo transformer circuits is in series. The disclosed method also includes driving the primary electroded side of the piezo transformer with an alternating signal; and generating a combined output of the plurality of piezo transformer circuits. The feature also provides for the conditioning of the output of the secondary side of the piezo transformer with a single signal conditioning component improving the efficiency of the circuit in comparison with conventional methods. The disclosed invention can take the form of an entirely hardware embodiment, or an embodiment containing both hardware and software elements. In at least one embodiment, the invention is implemented in software, which includes but is not limited to firmware, resident software, microcode, etc.

Although specific example embodiments have been illustrated and described herein, those of ordinary skill in the art appreciate that other variations, aspects, or embodiments may be contemplated, and/or practiced without departing from the scope or the spirit of the appended claims.

1. A piezoceramic transformer comprising:
at least one piezo transformer assembly, said at least one piezo transformer assembly being comprised of a plurality of piezo transformer circuits including a first outer and last outer piezo transformer circuit, each said piezo transformer circuit having a primary side having at least a positive and negative electrode and a secondary side having at least a positive and a negative electrode;
each of said plurality of piezo transformers circuits forming said piezo transformer assembly being coupled to an adjacent piezo transformer circuit wherein the positive electrode of the primary side of each said piezo transformer circuit is coupled to a first node and each negative electrode of the primary side of each piezo transformer circuit is coupled to a second node;
a signal conditioning component having first and second inputs, the positive electrode of the secondary side of said first outer piezo transformer circuit of said piezo transformer assembly coupled to the first input of said signal conditioning component and the negative electrode of the secondary side of said last outer piezo transformer circuit of said piezo transformer assembly;
wherein said negative electrode of said first outer piezo transformer circuit of said piezo transformer assembly is coupled to the positive electrode of a piezo transformer circuit of the plurality and said negative electrode of said secondary side of a piezo transformer circuit of the plurality being coupled to the positive electrode of said second outer piezo transformer circuit.

2. The device of claim 1 wherein said plurality of said piezo transformer circuits forming said piezo transformer assembly are configured to function as a step-down type transformer.

3. The device of claim 1 wherein said plurality of said piezo transformer circuits forming said piezo transformer assembly are configured to function as a step-up type transformer.

4. The device of claim 1 wherein said signal conditioning component is a rectifier.

5. The device of claim 1 wherein said signal conditioning component is an inverter.

6. A piezo transformer comprising:
a plurality of piezo transformer circuits forming at least one piezo transformer assembly, each of said piezo transformer circuits of said piezo transformer assembly having a primary side and a secondary side, wherein said primary side of said piezo transformer circuits of the piezo transformer assembly are coupled in parallel, and said secondary side of said piezo transformer circuits of the piezo transformer assembly are coupled in series, wherein said secondary side of said series coupled piezo transformer circuits of said piezo transformer assembly generate a single output voltage.

7. A method for transforming an electrical signal comprising:
employing a piezo transformer assembly, said piezo transformer assembly having a plurality of piezo transformer circuits, each said piezo transformer circuit having a primary side with a plurality of input electrodes and a secondary side having a plurality of output electrodes;
coupling the input electrodes of said primary side of each said piezo transformer circuits such that the primary side of said piezo transformer circuits are oriented in parallel;
coupling the electrodes of said secondary side of said piezo transformers such that the orientation of the secondary side of said piezo transformer circuits are in series;
driving said primary side of said piezo transformer circuits with an electrical signal;
generating a single output voltage for the plurality of piezo transformer circuits.

8. The method for transforming an electrical signal of claim 7 further comprising conditioning said output voltage of the secondary side of said piezo transformer assembly.

9. The method for transforming an electrical signal of claim 8 further comprising conditioning said output of the secondary side of said piezo transformer assembly with a single signal conditioning circuit.

10. The piezo transformer of claim 6 further comprising at least one signal conditioning component coupled to said secondary side of said piezo transformer.

11. The method for transforming an electrical signal of claim 7 further comprising generating multiple selectable voltage output signals for the plurality of piezo transformer circuits.

12. A piezo transformer comprising:
a plurality of piezo transformer circuits forming at least one piezo transformer assembly, each of said piezo transformer circuits of said piezo transformer assembly having a primary side and a secondary side,
wherein said primary side of said piezo transformer circuits of the piezo transformer assembly and said secondary side of said piezo transformer circuits of the piezo transformer assembly are connected in a concatenated topology causing a multiplication of the output power level at the secondary side of said piezo transformer assembly.

13. The apparatus of claim 12 further comprising a signal conditioning circuit operatively coupled to said multiplied ac power output of the secondary side of said piezo transformer assembly.

14. The apparatus of claim 12 wherein said concatenated topology includes the primary side of said piezo transformer circuits of the piezo transformer assembly coupled in parallel, and said secondary side of said piezo transformer circuits of the piezo transformer assembly coupled in series, wherein said secondary side of said series coupled piezo transformer circuits of said piezo transformer assembly produces a concatenated output signal.

15. The apparatus of claim 14 wherein said secondary side of said piezo transformer circuits further includes at least one switch assembly for generating multiple selectable voltage output signals from said plurality of piezo transformer circuits.
